(19) United States
(12) Patent Application Publication
(10) Pub. No.: US 2017/0206329 A1
(43) Pub. Date: Jul. 20, 2017

(54) MOBILE DIAGNOSTICS LABORATORY, COMMUNICATIONS SYSTEMS, AND RELATED METHODS

(71) Applicant: FlowMetric Diagnostics Inc., Doylestown, PA (US)

(72) Inventors: Renold Julius Capocasale, Mount Laurel, NJ (US); Robert Ellis Hilliard, Downingtown, PA (US); Julie Ann Bick, Easton, PA (US)

(21) Appl. No.: 15/406,062

(22) Filed: Jan. 13, 2017

Related U.S. Application Data
(60) Provisional application No. 62/278,985, filed on Jan. 15, 2016.

(51) Int. Cl. G06F 19/00

(52) U.S. Cl. CPC G06F 19/3418; G06F 19/322

(57) ABSTRACT

A mobile laboratory for screening patients using blood testing is provided. The mobile laboratory includes: a cell analyzer platform for testing of blood samples; a computer for receiving and analyzing data from the cell analyzer platform related to the tested blood samples; and a communication device, in communication with the computer, for transmitting data related to the tested blood samples from the computer to a third party.

### CROSS-REFERENCE TO RELATED APPLICATION

This application claims the benefit of U.S. Provisional Application No. 62/278,985, filed Jan. 15, 2016, the contents of which are incorporated herein by reference.

### FIELD

The invention relates generally to the field of diagnostic medicine. More particularly, the invention relates to off-grid mobile laboratories that can be deployed in remote areas of the world to conduct on-site, point-of-care medical diagnostics (e.g., blood testing) for applications such as, for example: (i) immune system monitoring for infectious disease screening, and (ii) the monitoring of immunological reactions to specific allergens and antigens. Embodiments of the invention relate to a multiple-mode communication platform for real-time diagnoses through template (e.g., algorithm) driven data analysis and real-time communication with off-site health care providers, health care authorities, and government agencies. Such processes have the benefit of substantially reducing the movement of populations to central locations for screening, and in so doing, minimizes the spread of infection within highly populated, central locations.

### BACKGROUND

Various publications, including patents, published applications, technical articles and scholarly articles are cited herein. Each of these cited publications is incorporated by reference herein, in its entirety, and for all purposes.

Infectious diseases remain a health concern in many regions of the world. Many of the regions are impoverished, remote, and/or resource-poor, and many of these regions include a nomadic population. The mobility of the population makes identifying, tracking, and treating infected individuals a major challenge. Lack of a capacity to make appropriate diagnoses, and to devise appropriate interventions in such regions of the world, perpetuate and spread infection. Furthermore, the movement of infected individuals across country borders represents a major risk of disease spreading to the population of both developing and developed countries of the world (See, e.g., Weekly Epidemiological Record Nos. 51/52, 16 Dec. 2016, pages 601-624). Challenges to providing effective infectious disease management in remote locations are considered in various publications (See, e.g., (i) Mabey, D., Peeling, R. W., Ustianowski, A., & Perkins, M. D. (2004, March), Diagnostics for the Developing World, Nature Reviews: Microbiology, and (ii) Peeling, R. W., & Mabey, D. (2010 Jul. 23), Point-of-care tests for diagnosing infections in the developing world, European Society of Clinical Microbiology and Infectious Diseases).

Thus, improved capabilities for mobile diagnostics laboratories, communications systems, and related methods, would be desirable.

### SUMMARY

According to an exemplary embodiment of the invention, a mobile laboratory for screening patients using blood testing is provided. The mobile laboratory includes: a cell analyzer platform for testing of blood samples; a computer for receiving and analyzing data from the cell analyzer platform related to the tested blood samples; and a communication device, in communication with the computer, for transmitting data related to the tested blood samples from the computer to a third party.

According to another exemplary embodiment of the invention, a communication system is provided. The communication system includes: (a) a computer for providing data to be transmitted; (b) a satellite transceiver configured to transmit data from the computer to a third party in a location remote from the communication system; (c) at least one back-up transceiver (e.g., cellular, Wifi, radio, etc.), as a back-up to the satellite transceiver, configured to transmit data from the computer; and (d) an enclosure which holds the computer, the satellite transceiver, and the at least one back-up transceiver.

According to yet another exemplary embodiment of the invention, a method of operating a communication system is provided. The method includes the steps of: (a) providing a communication system including a computer, a satellite transceiver configured to transmit data from the computer to a third party, at least one back-up transceiver, and an enclosure for holding the computer, the satellite transceiver, and the at least one back-up transceiver; (b) transmitting data from the computer to the third party at a remote location using the satellite transceiver; and (c) transmitting data from the computer to the third party at the remote location using the at least one back-up transceiver.

According to yet another exemplary embodiment of the invention, a method of assembling patient data for transmission from a mobile laboratory is provided. The method includes the steps of: (a) obtaining biometric data related to a patient; (b) obtaining biological data related to the patient, the biological data including test results provided by a cell analyzer platform; (c) linking the biometric data and the biological data; and (d) transmitting the linked biometric data and biological data from the mobile laboratory to a remote location.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a perspective view of a mobile laboratory and a trailer in accordance with an exemplary embodiment of the invention;

FIG. 1B is a front view of a mobile laboratory in accordance with an exemplary embodiment of the invention;

FIG. 1C is a back view of the mobile laboratory of FIG. 1B;

FIG. 1D is a side view of the mobile laboratory of FIG. 1B;

FIGS. 1E-1H are various top views of the mobile laboratory of FIG. 1B with a plurality of solar panels in various positions of extension and retraction;

FIG. 2 is a block diagram illustrating various components, and electrical power and data transfer interconnections, of a mobile laboratory in accordance with an exemplary embodiment of the invention;

FIG. 3 is a block diagram of a communication system of a mobile laboratory in accordance with an exemplary embodiment of the invention;

FIG. 4 is a flow diagram illustrating a method of operating a communication system in accordance with an exemplary embodiment of the invention;

FIG. 5 is a block diagram illustrating a linked data record in a computer system in accordance with an exemplary embodiment of the invention;

FIG. 6 is a flow diagram illustrating a method of assembling patient data in accordance with an exemplary embodiment of the invention; and

FIGS. 7A-7F illustrate various portable cases for mobile laboratories in accordance with various exemplary embodiments of the invention.

### DETAILED DESCRIPTION

Various terms relating to aspects of the invention are used throughout the specification and claims. Such terms are to be given their ordinary meaning in the art, unless otherwise indicated. Other specifically defined terms are to be construed in a manner consistent with the definition provided herein.

As used herein, the singular forms “a,” “an,” and “the,” include plural referents unless expressly stated otherwise. The terms measure or determine are used interchangeably, and refer to any suitable qualitative or quantitative determinations.

The terms subject or patient are used interchangeably. A subject may be any animal, including mammals such as companion animals, laboratory animals, and non-human primates. Human beings are exemplary subjects or patients.

In remote or isolated regions of the world (e.g., in parts of the African continent, the tropics, etc.), infectious diseases remain a major health concern (See, e.g., Wondwossen A. Gebreyes, Jean Dupouy-Camet, Melanie J. Newport, Celso J. B. Oliveira, Larry S. Schlesinger, Yehia M. Saif, Samuel Kariuki, Linda J. Saif, William Saville, Thomas Wittum, Armando Hoet, Sylvain Quessy, Rudovick Kazwala, Berhe Tekola, Thomas Shryock, Michael Bisesi, Prapas Patchanee, Sumalee Boonmar, and Lonnie J. King. (2014, November), PLOS Neglected Tropical Diseases, 8(11), e3257, The Global One Health Paradigm: Challenges and Opportunities for Tackling Infectious Diseases at the Human, Animal, and Environment Interface in Low-Resource Settings).

Many such regions lack the infrastructure for appropriate diagnoses and correct treatment of a given pathogenic infection. Compounding that problem is the fact that many indigenous populations are nomadic such that individuals and groups frequently migrate to different locations, making infected individuals difficult to track. Relatedly, many indigenous populations do not have surnames or consistent means of identification. Certain exemplary embodiments of the invention overcome certain of these problems by identifying, monitoring, and tracking patients, as well as with making cost-effective and accurate diagnoses for enhanced control of infections and the spread of communicable diseases, and the effective tracking of individuals for population health-related surveillance programs including monitoring the effectiveness of vaccinations programs. Such issues have been considered, for example, in: (i) Couig, M., (2006, January), The Online Journal of Issues in Nursing, Vol. 11, No. 1, Overview and Summary: Infectious Diseases: Challenges and Solutions; and (ii) Alejandro E. Macias and Samuel Ponce-de-Leon, (2005, May) Archives of Medical Research 36, p. 637-645, REVIEW ARTICLE, Infection Control: Old Problems and New Challenges.

Benefits of the invention may include, for example: (i) the implementation of effective screening practices of remote populations, substantially reducing the desirability of their movement into highly populated areas for testing; (ii) the training of regional healthcare providers on state-of-the-art diagnostics; (iii) providing rapid and robust diagnostic platforms that can provide same-day clinical testing; (iv) providing testing platforms using only small volumes of blood, and potentially eliminating venous blood draw, use of needles and bio-waste generation; (v) automating onsite processing of clinical data by validated algorithms, enabling test data to be readily available and interpretable by healthcare technicians at the point of care; (vi) providing real-time analysis of data by remote physicians; and (vii) providing the capability to track of nomadic individuals within a region.

In accordance with aspects of the invention, a mobile laboratory is provided for the rapid screening of patients through blood testing (e.g., testing for infection with one or more pathogens, testing related to antigens or genes, screening of an individual's immunological status such as vaccine efficacy and/or sensitivity of an individual to allergens, etc.). Such a mobile laboratory may include a cell analyzer platform (e.g., a flow cytometer, a fluorescent microscope, etc.) for analyzing small volumes of capillary blood, or venous blood. The cell analyzer platform performs highly sensitive, analytical, tests on the blood samples. A computer receives and analyzes data from the cell analyzer platform (where such analyses are automated in the mobile laboratory) related to the tested blood samples. Software on the computer (and/or remotely accessible by the computer) provides rapid and accurate analysis of samples using template (e.g., algorithm) driven analytics, thereby minimizing or eliminating the requirement for expert technicians in the field for data processing. Such analytics are discussed, for example, at: (i) Nima Aghaeepour, Greg Finak, The FlowCAP Consortium, The DREAM Consortium, Holger Hoos, Tim R Mosmann, Ryan Brinkman, Raphael Gottardo, Richard H Scheuermann (2013, March) Critical assessment of automated flow cytometry data analysis techniques, Nature Methods, Volume 10, No. 3, pages 228-238; and (ii) Lo K, Brinkman R R, Gottardo R (2008, April) Cytometry Part A, 73(4), pages 321-32, Automated Gating of Flow Cytometry Data via Robust Model-Based Clustering.

The mobile laboratory may also include a biometric reader for patient identification that can be linked directly and securely to clinical data, and a communication device (in communication with the computer) for transmitting data related to the tested blood samples from the computer to a third party such as the CDC, WHO for infection tracking. Such infection tracking, and related subjects, are considered, for example, at: (i) Karen Ross (2006, September) EMBO Reports, 7(9), pages 855-858, Tracking the spread of infectious disease: Two networks prove the power of international collaboration; and (ii) World Health Organization, Media centre, Global infectious disease surveillance, Fact Sheet No. 200, 2016.

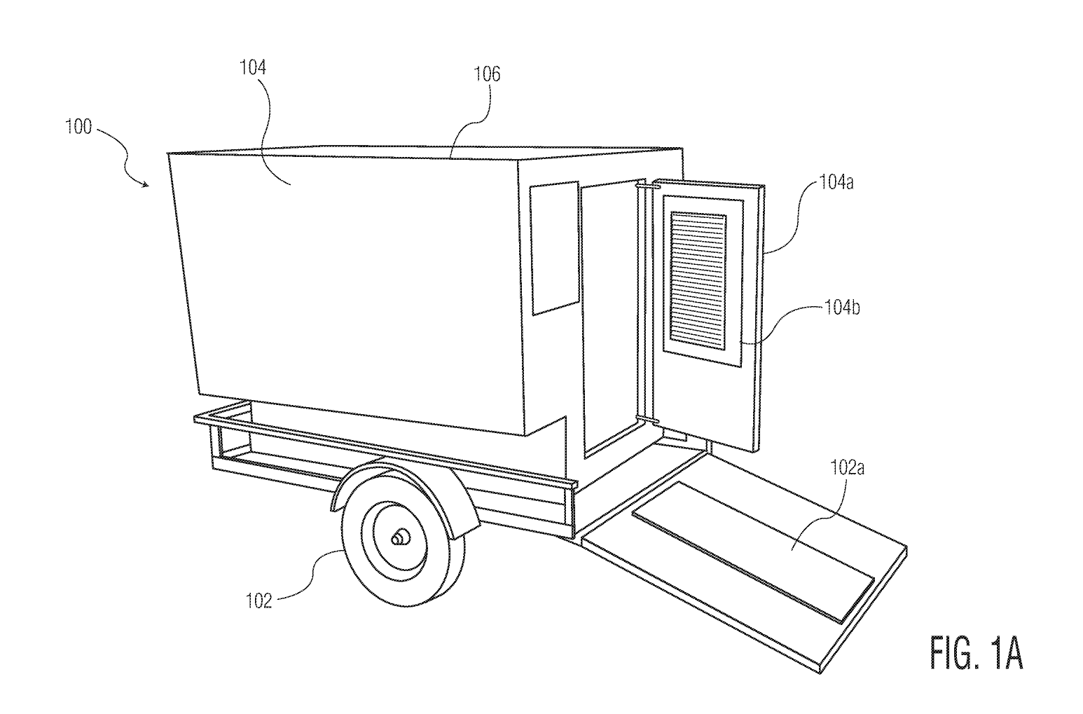

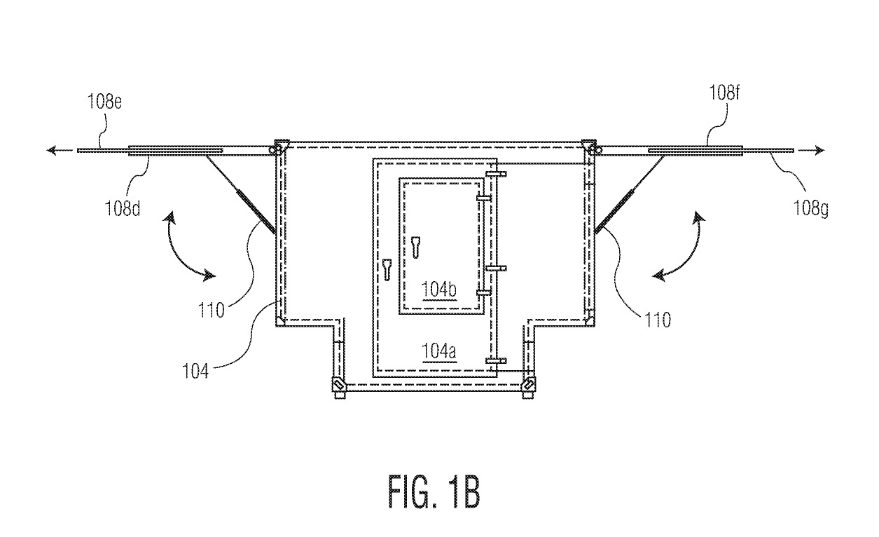

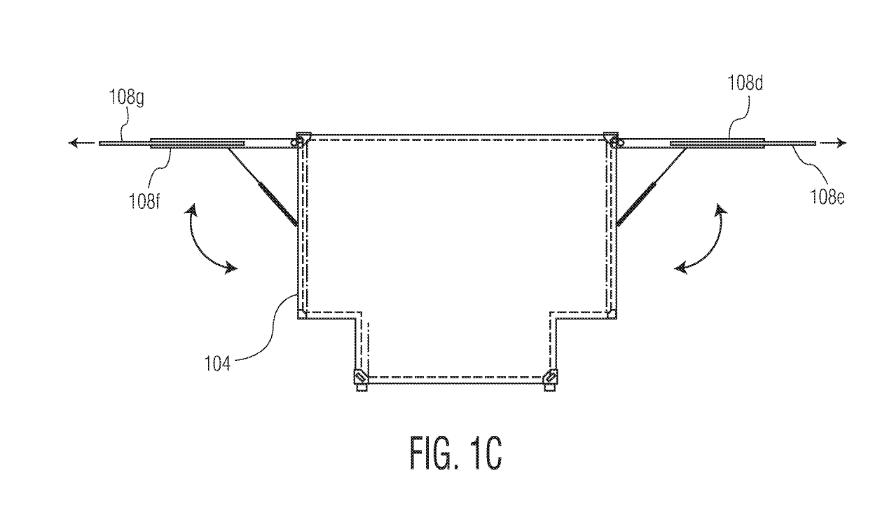

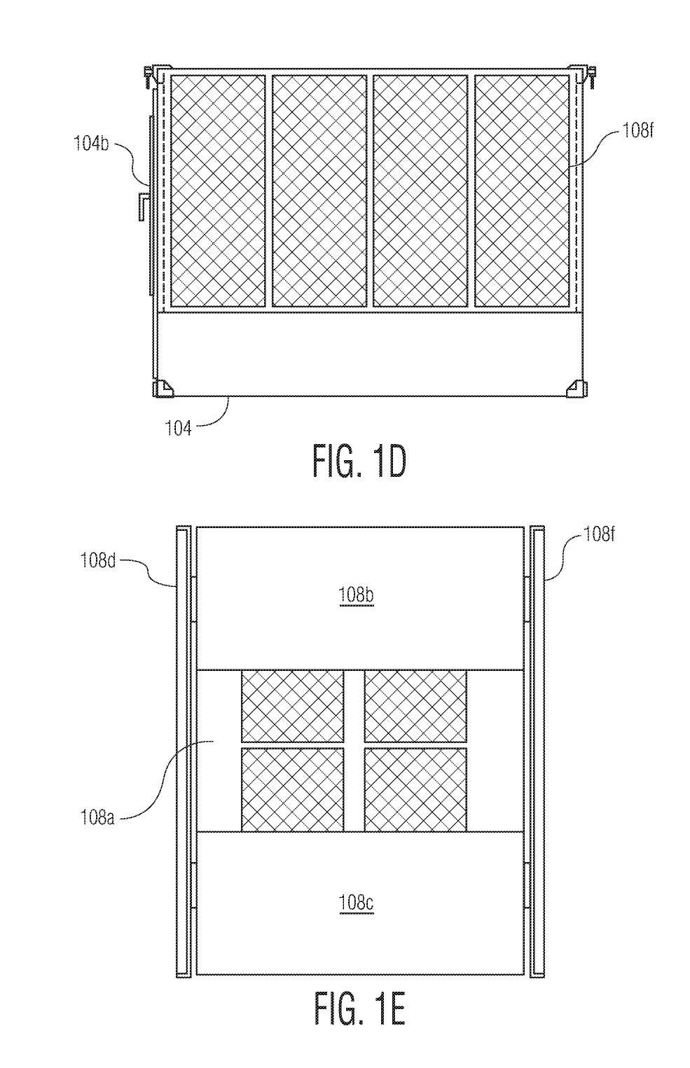

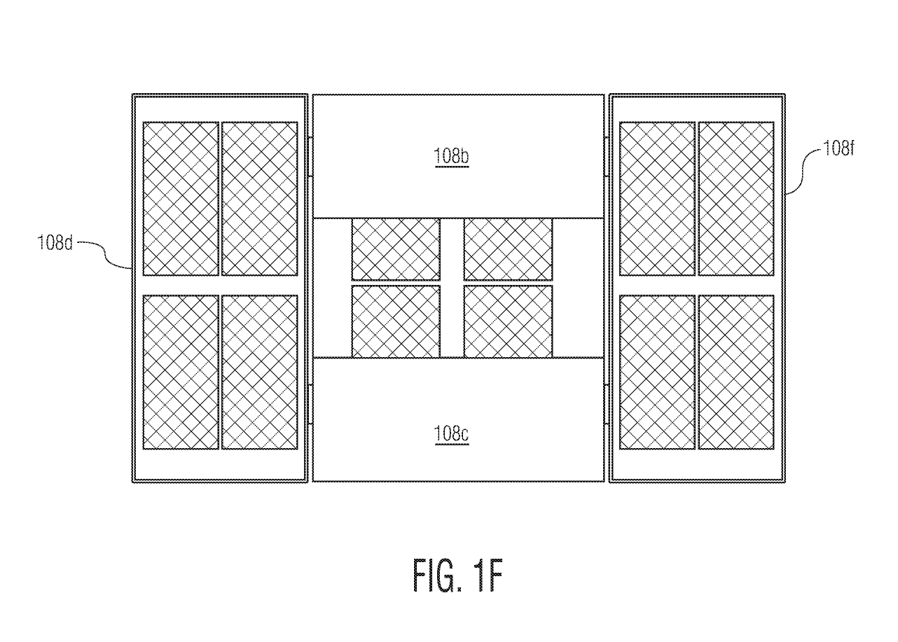

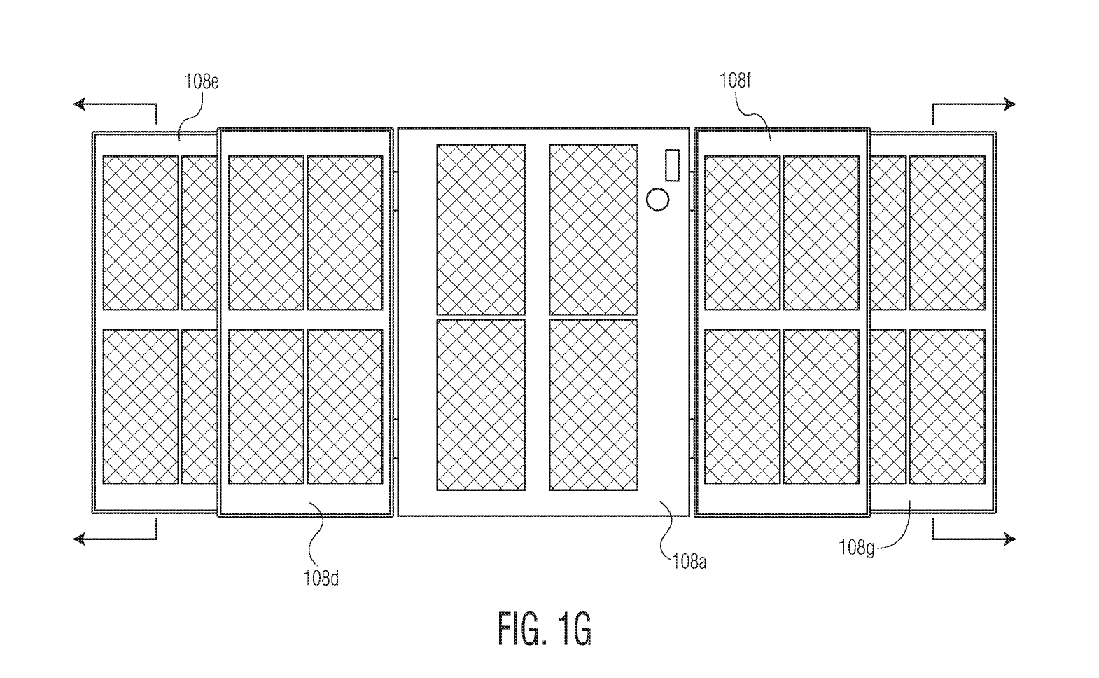

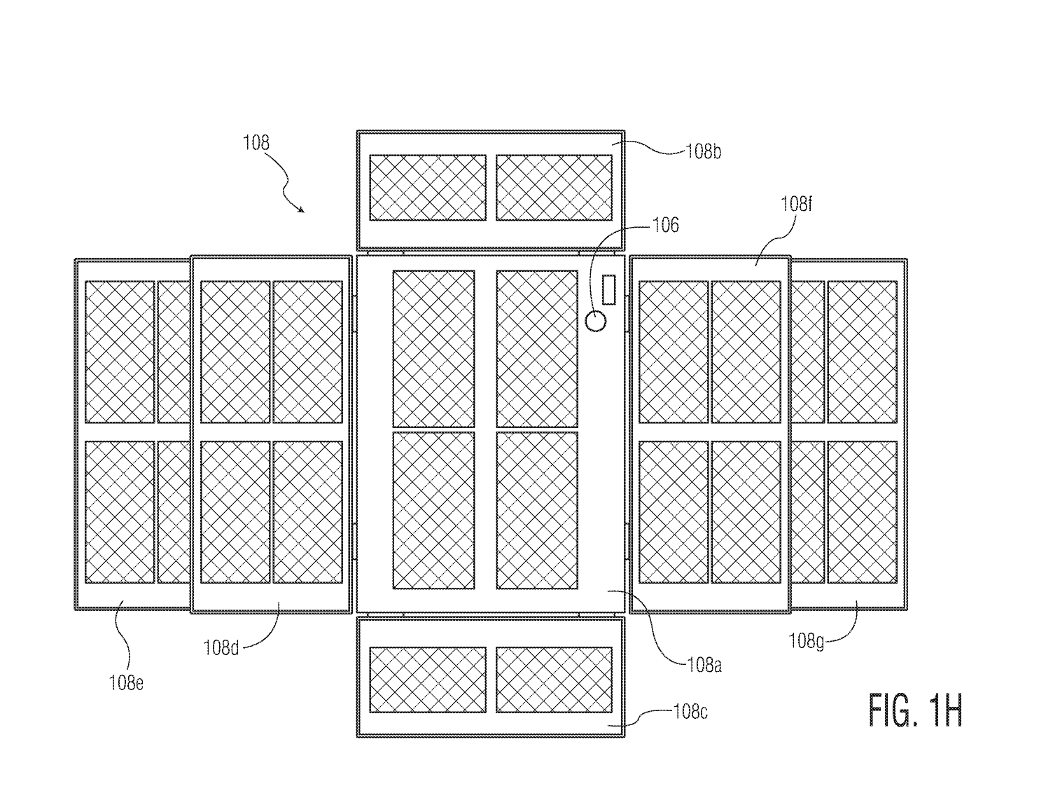

Aspects of the invention relate to processes around the performance of diagnostic analysis in remote locations using a mobile diagnostic laboratory system containing cellular analytical equipment such as a flow cytometer. The processes may include the interpretation of clinical data via analytical templates, for rapid and precise diagnostic analysis in remote locations, and the linkage of this data with a biometric profile for effective patient tracking. Such a mobile laboratory system may be compact and portable, and be self-contained such that it may be readily deployed in any region of the world, no matter how remote. The system may be self-powered (e.g., including solar arrays as illustrated in FIGS. 1B-1H) with alternative power sources such as generator, wind, water-turbine, battery, and, accordingly, may not require a power infrastructure in order to be operational. The system further includes a plurality of alternative communication sources (e.g., including various formats of radio communication that may be used simultaneously as well as having integrated bidirectional cellular jamming technology, and high input video streaming capability) and, accordingly, does not require cellular or wired communication infrastructure in order to be operational. The communication sources allow operators of the system to be in real-time communication with a third party (e.g., a health care providers, a health authorities anywhere in the world, etc.) in order to assist the system operators in making diagnoses, devising a course of treatment, and/or quarantining appropriate to the needs of particular individuals, groups, or populations. The system further includes laboratory equipment for running a diagnostic modality tailored for mobile applications, as well as data equipment for collecting information about patients being screened through operation of the system.

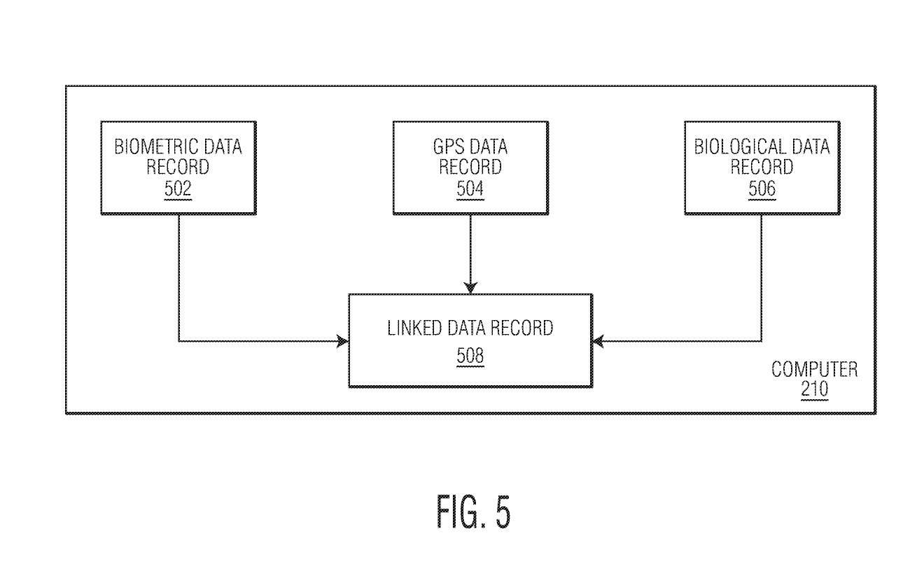

The mobile diagnostic laboratory system may include a biometric input for collection of patient biometric information and data (e.g., biometric data record 502 shown in FIG. 5). The patient biometric information and data may be used, for example, to identify, monitor, and track individual patients as well as particular groups of patients or populations over the course of a treatment or wellness assessment, or for outbreak monitoring and control, or for other epidemiologic evaluation. The patient biometric information and data may be used as part of the diagnostic testing carried out using the mobile diagnostic laboratory system, for example, to keep track of individual patient samples, tests, and diagnoses within the system, as well as related communications and follow-up concerning these samples, tests, and diagnoses. Remote health monitoring systems are considered, for example, at U.S. Pat. No. 7,399,276, titled “Remote Health Monitoring System”.

Patient biometrics may include any suitable information to identify, monitor, and track individual patients as well as particular groups of patients or populations. Biometrics may include one or more of a DNA/gene sequence, fingerprint, toe print, palm print, hand palm vein signature, hand geometry, facial pattern, iris recognition, retina recognition, voice recognition, any combination thereof, amongst others.

Patient characteristics may also be entered into the system via the biometric input (such as biometric data record 502 in FIG. 5). Patient characteristic include, but are not limited to, name, age, sex, vital statistics, health history, physical characteristics (e.g., height, weight, etc.), race, ethnicity, family history, blood type, HLA haplotype, or genetic test results. Patient characteristics may be used in combination with patient biometrics in some aspects.

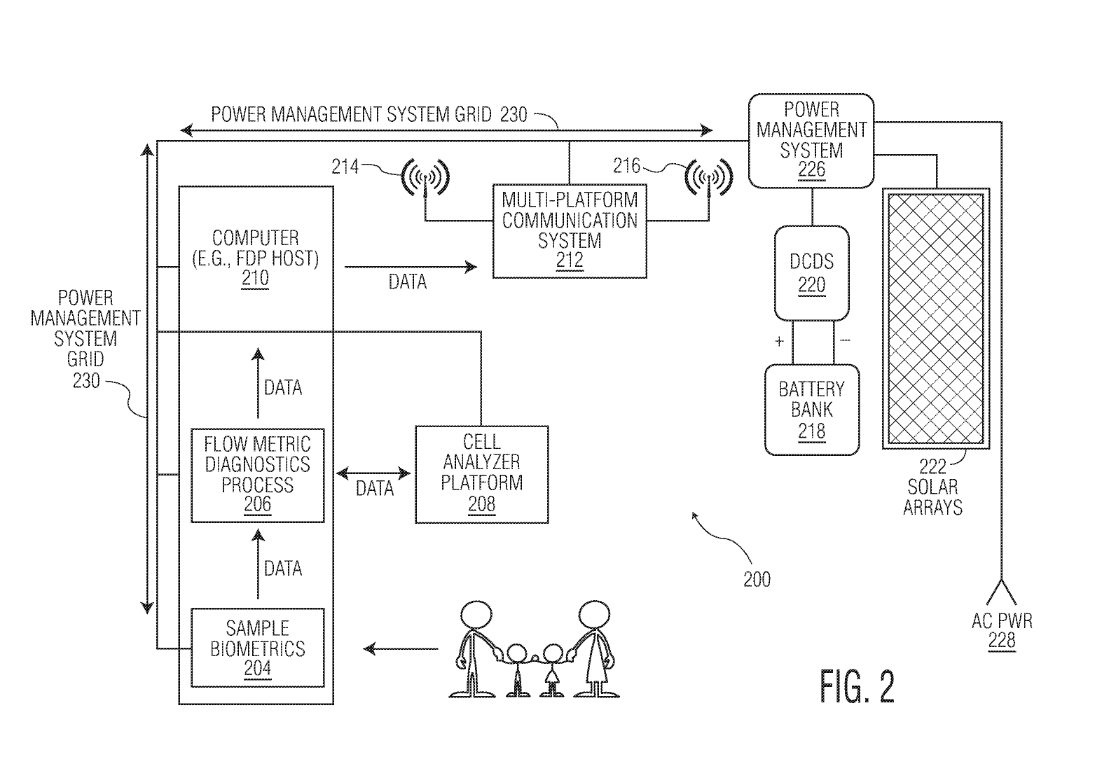

Patient biometrics may be provided using a biometric input device included in the mobile laboratory such as a camera, a fingerprint scanner, a toe print scanner, a palm vein scanner, a facial scanner, an eye (iris and/or retina) scanner, a microphone, a DNA sequencer, any combination thereof, among others. A global positioning system (GPS) tracking component may be used to assign a GPS stamp to biometrics collected and/or otherwise entered. A clock (e.g., through a computer such as computer 210 shown in FIG. 2) may also be used to assign a date and time stamp to biometrics collected and/or otherwise entered.

In accordance with certain exemplary embodiments of the invention, processes of rapid diagnostic testing may be performed with low volumes of blood, where such processes (i) utilize template (e.g., algorithm) driven automated analysis of clinical data, (ii) link this data with a biometric profile of the patient along with GPS location of the test site, and (iii) communicate this data package to remote locations for use in tracking and surveillance programs (e.g., patient tracking). Mobile laboratories in accordance with the invention include computers that may include (or may access) computer program instructions (software) for template driven analysis of blood samples, therefore utilizing a basic-level of local technical support. That is, at the time of operating the mobile laboratory in the field, strong technical support may be difficult to obtain. By automating the analysis of the blood sample taken from a patient, there is less potential for error.

Referring now to the drawings, FIG. 1A illustrates mobile laboratory 100 including a trailer 102 (having a ramp 102a) and a housing 104 (including door 104a). Door 104a includes subdoor 104b, where subdoor 104b provides an emergency exit and venting from housing 104. An antenna 106 (which may represent a plurality of antennas for transmission of data using various transmission mechanisms) is provided for transmission and/or reception of data to a remote location.

FIGS. 1B-1C are front and rear views of a housing 104. A plurality of solar panels are provided on housing 104, as shown in FIGS. 1B-1H (where such solar panels are not visible in FIG. 1A). FIG. 1B illustrates solar panels 108d and 108f in an extended position, supported by hydraulic struts 110. Solar panels 108d, 108f house solar panels 108e, 108f (where solar panel 108e is housed within solar panel 108d in a retracted position, and slides out of solar panel 108d in an extended position as shown in FIGS. 1B-1C) (where solar panel 108g is housed within solar panel 108f in a retracted position, and slides out of solar panel 108f in an extended position as shown in FIGS. 1B-1C).

FIG. 1D is a side view of housing 104 illustrating solar panel 108f in a retracted position, that is, with solar panel 108g slid inside solar panel 108f, and with solar panel 108f hinged and rotated downward (with hydraulic struts retracted). FIG. 1E is a top view of housing 104 illustrating solar panels 108d, 108f in a retracted position. FIG. 1E also illustrates solar panels 108b, 108c in a retracted position, hinged and rotated on top of housing 104. That is, FIG. 1E illustrates all of the solar panels in a retracted position for travelling.

FIG. 1F illustrates solar panels 108d, 108f in an extended position (similar to the view of solar panels 108d, 108f in FIGS. 1B-1C). FIG. 1G illustrates solar panel 108e being extended (slid) from solar panel 108d, and solar panel 108g being extended (slid) from solar panel 108f (in FIG. 1G, solar panels 108b, 108c are removed for simplicity). FIG. 1H is similar to the view of FIG. 1G, except that solar panels 108b, 108c are included and shown in an extended position. That is, solar panels 108b, 108c have been hinged and rotated from the retracted position shown in FIGS. 1E-1F to the extended position shown in FIG. 1H.

Thus, FIGS. 1A-1H collectively illustrate various external features of a mobile laboratory 100.

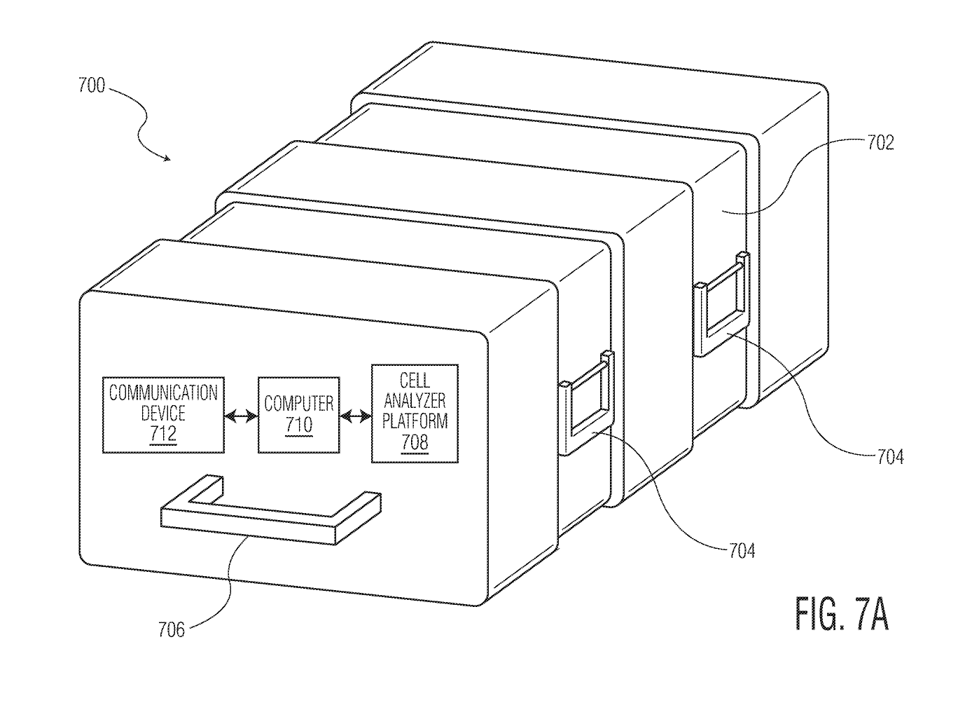

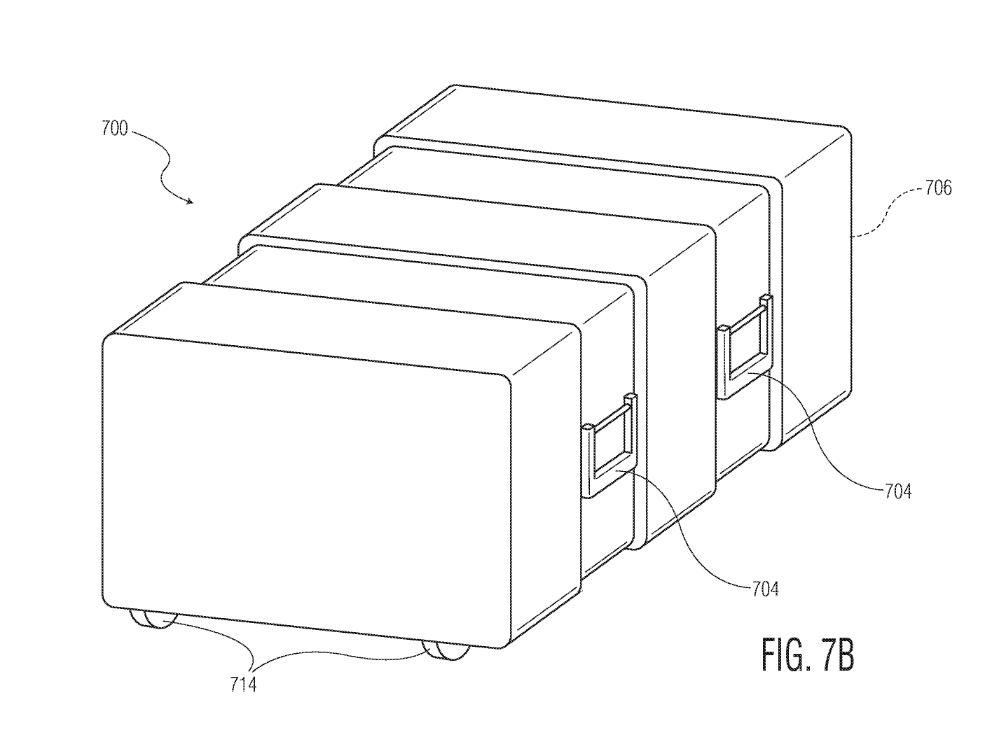

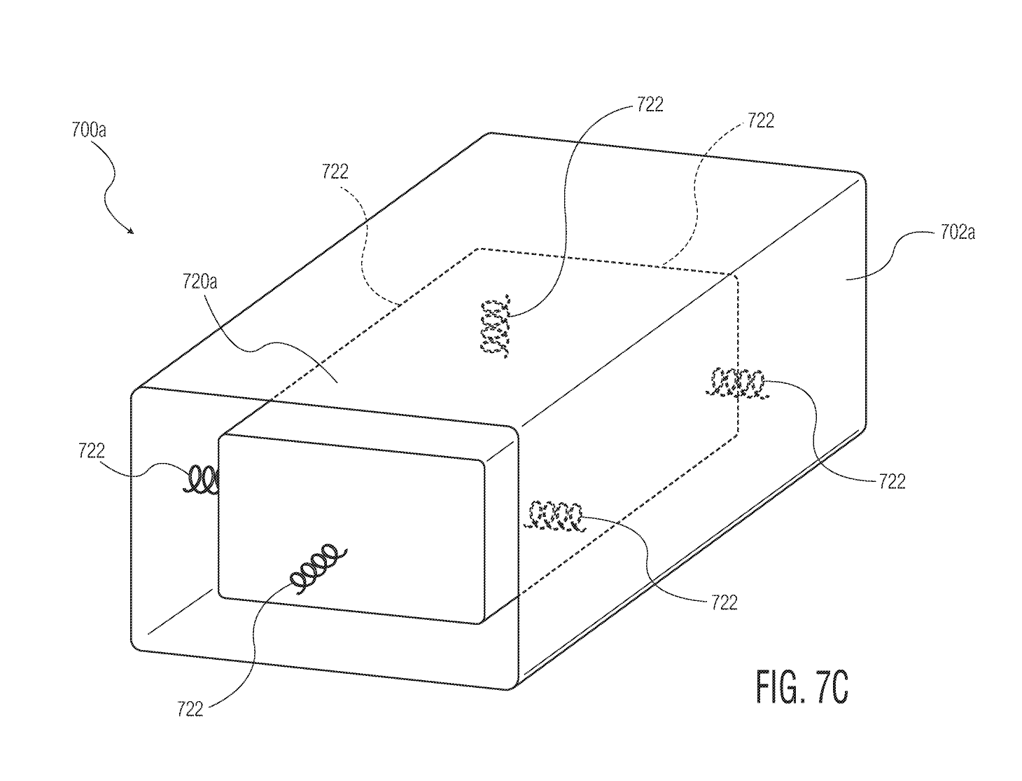

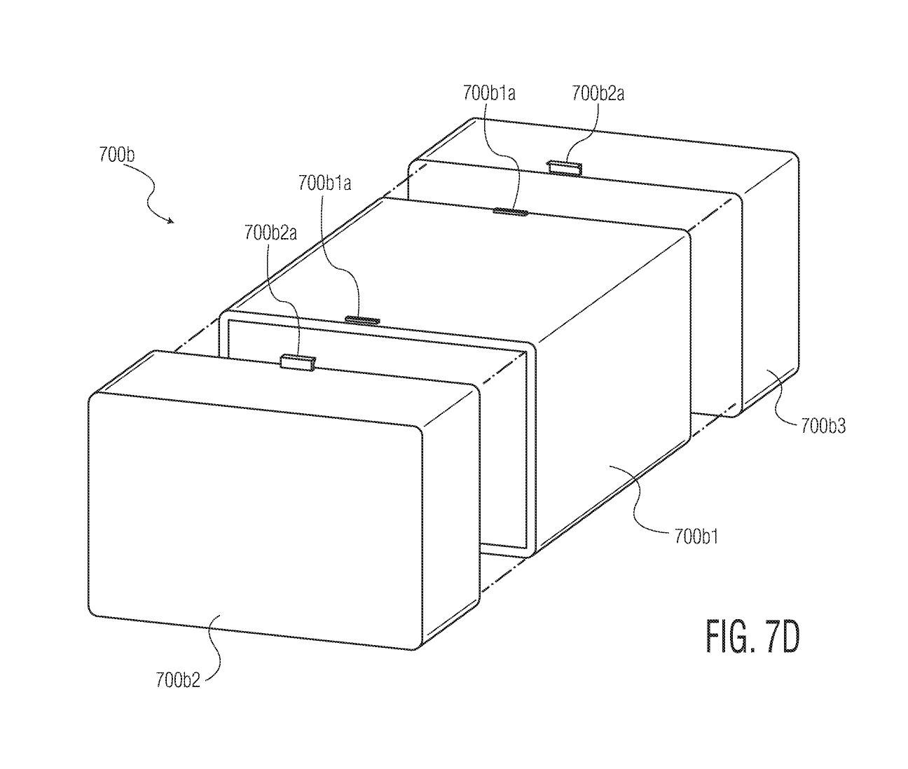

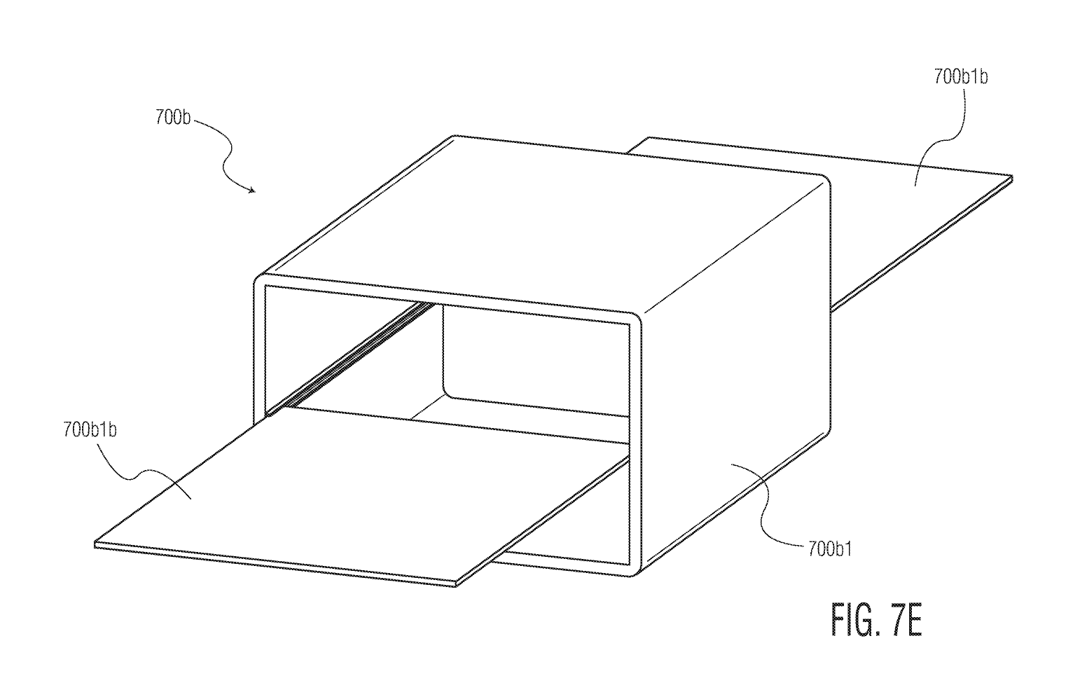

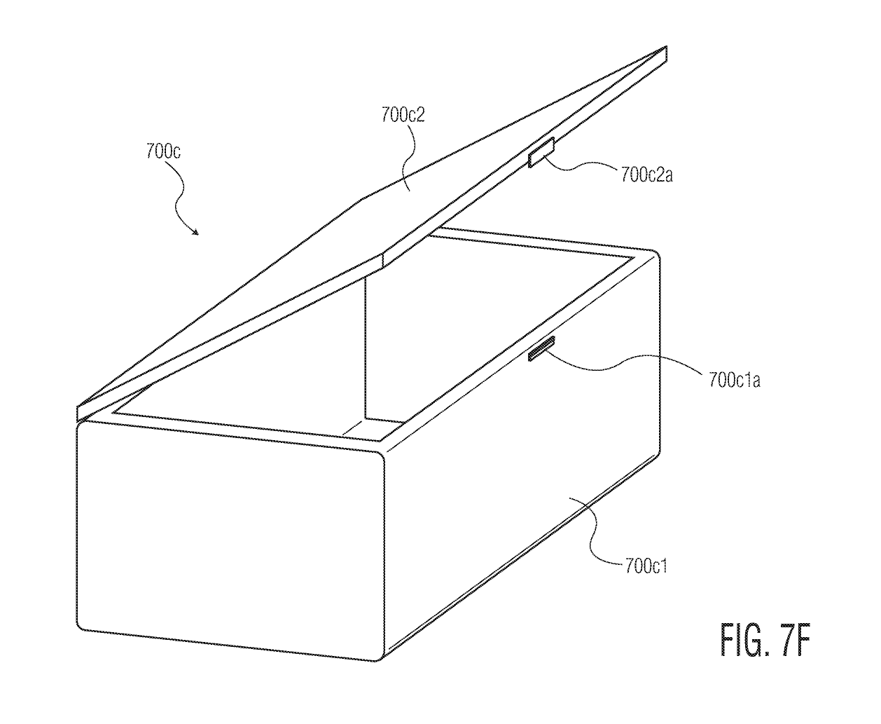

FIG. 2 is a block diagram of various elements and related processes of a mobile laboratory 200, where according to an exemplary embodiment of the invention elements included in mobile laboratory 200 may be included in mobile laboratory 100 shown in FIGS. 1A-1H. Alternatively, elements included in mobile laboratory 200 may be included in a mobile laboratory housed in a portable case, such as is shown the exemplary cases shown in FIGS. 7A-7F.

In FIG. 2, patients (illustrated as a group of 4 people) have arrived at mobile laboratory 200. At this time, sample biometric data 204 (also referred to herein as “patient biometrics”) and patient characteristics are taken (e.g., and stored in computer 210) related to a given one of the patients. Such biometric data 204 may include, for example, fingerprint scan data of the patient, a digital photograph of the patient, other patient biometrics described herein, etc. A blood sample is also taken related to the patient, and after processing the sample is further processed using a cell analyzer platform 208 (e.g., a flow cytometer, a fluorescent microscope, etc.). Data from cell analyzer platform 208 is analyzed using a diagnostic process 206 (e.g., via computer 210) to provide biological data. Such biological data includes, for example, outcome testing information such as clinical results of testing for specific infectious pathogens. The biological data is linked to biometric data 204 (and the patient characteristics) for the respective patient, also at the diagnostic process 206 (via computer 210).

Although not illustrated in FIG. 2, GPS satellite position data may also be linked to the biological data and the biometric data 204 (via computer 210). Data related to the patient (i.e., linked data including biometric data, biological data, GPS satellite position data, etc.) is transmitted from computer 210 to a remote third party (e.g., a global health organization) using multi-platform communication system 212. As will be explained in greater detail below, multi-platform communication system 212 uses a plurality of transmitters 214, 216 (e.g., satellite transceiver, cellular telephone transceiver, software defined radio, free wave radio, WIFI transceiver, etc.) to send data to the remote third party (and perhaps to receive information from the third party). As used herein, the term transceiver is intended to refer to devices including a transmitter and a receiver, regardless of whether such devices share common circuitry or a single housing; that is, the term transceiver includes transmitter-receiver devices.

The data transmitted to the remote third party may include data for a plurality of patients at a given location (e.g., a geographic region), thereby allowing the third party (or other parties) to have an improved understanding of medical issues of groups of patients in the given location. The system also enables tracking data of individual patients, and groups of patients such as those in a given location, over a period of time. By transmitting the data to the remote location, real-time post acquisition analysis is enabled locally at the mobile laboratory, and remotely.

FIG. 2 also illustrates a power distribution system to provide power to various elements of mobile laboratory 200. Alternating current (AC) power 228 is provided to power management system 226. For example, AC power 228 may be provided at a nominal 120 V AC, 220 V AC, etc. This AC power 228 is converted to the desired DC power level (e.g., 19 volts DC) at the power management system 226. Solar arrays 222 (e.g., such as the collection of solar panels provided on housing 104 and illustrated in FIGS. 1B-1H) provides electrical power to the power management system 226, for example, at a desired DC voltage level (e.g., 19 volts). The DC power from solar arrays 222 may also used to charge battery bank 218. DC power from battery bank 218 is provided to power management system 226 through DC disconnect switch 220. Thus, three different sources of electrical power (i.e., AC power 228, solar arrays 222, and battery bank 218) are used to provide power to the power management system 226. The 3 different sources may be provided in any desired configuration. For example, the 3 sources may be in continuous operation and connection, such that there is automatic back-up and redundancy. Alternatively, manual switching, or automatic switching depending on availability of a primary source versus a secondary source, are other exemplary configurations that are contemplated.

The output power (e.g., 19 volts DC, or whatever desired voltage level) from power management system 226 is used to establish the power management system grid 230. In certain exemplary embodiments of the invention, all powered elements of the mobile laboratory may utilize the same DC voltage, for example, cell analyzer platform 208, computer 210, the communication system, as well as other elements such as lighting, etc.

System 200 may also include unmanned area vehicle (UAV) control (not shown for simplicity), for example, which may be used to deliver supplies and/or information to the mobile laboratory via unmanned control.

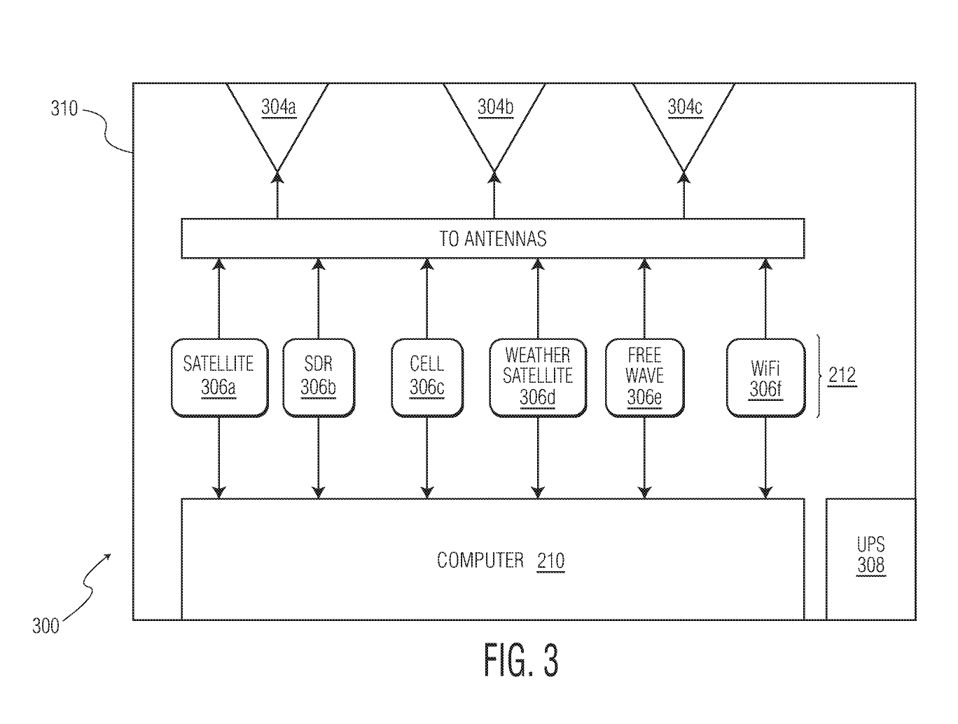

FIG. 3 is a block diagram of exemplary communication system 300. Exemplary communication system 300 includes certain elements from FIG. 2, for example, computer 210 and an exemplary multi-platform communication system 212. These, and other elements of communication system 300 are provided in a single enclosure 310 (e.g., a shielded aluminum enclosure that is less than 1 cubic foot in volume). Data from computer 210 (such as the linked biometric, biological, and GPS data related to one or more patients) is to be transmitted to a third party at a remote location (e.g., a global health organization). Communication system 300 includes various transmitters or transceivers in multi-platform communication system 212, including: satellite transceiver 306a; software defined radio 306b (e.g., dual band); cellular telephone transceiver 306c (e.g., a wireless communication transceiver, a 4G LTE transceiver, etc.); weather satellite transceiver 306d (e.g., a Doppler weather satellite receiver); free wave radio 306e; and WiFi transceiver 306f. One or more of these transmitters/transceivers are used to transmit the data using at least one of a plurality of antennas 304a, 304b, 304c. Although three antennas 304a, 304b, 304c are shown in connection with enclosure 310, it is understood that these antennas simply represent various antennas used to provide the transmission and reception paths for multi-platform communication system 212. As antennas 304a, 304b, 304c are included with enclosure 310, depending on which communication technology is used, cabling may be provided between ones of antennas 304a, 304b, 304c and antenna 106 (shown in FIG. 1A). FIG. 3 also illustrates an uninterruptible power supply (UPS) 308 within enclosure 310 with electrical connections omitted for simplicity, but being understood by those skilled in the art.

In accordance with an exemplary embodiment of the invention, one of the transmitters/transceivers may act as a primary communication mechanism, while others may be secondary or back-up communication mechanisms. In one embodiment, satellite transceiver 306a acts as the primary communication mechanism, and is configured to transmit data from computer 210 to a third party in a remote location. In such an embodiment, others (one or more) of the communication mechanisms in multi-platform communication system 212 may act as back-up transmitters/transceivers. In such an embodiment, communication system 300 may be configured to automatically switch to use at least one back-up transmitter/transceiver (e.g., cellular telephone transceiver 306c) to transmit data from computer 210 upon a determination that satellite transceiver 306a is unavailable. Of course, the switching between the communication mechanisms may also be manual, if desired.

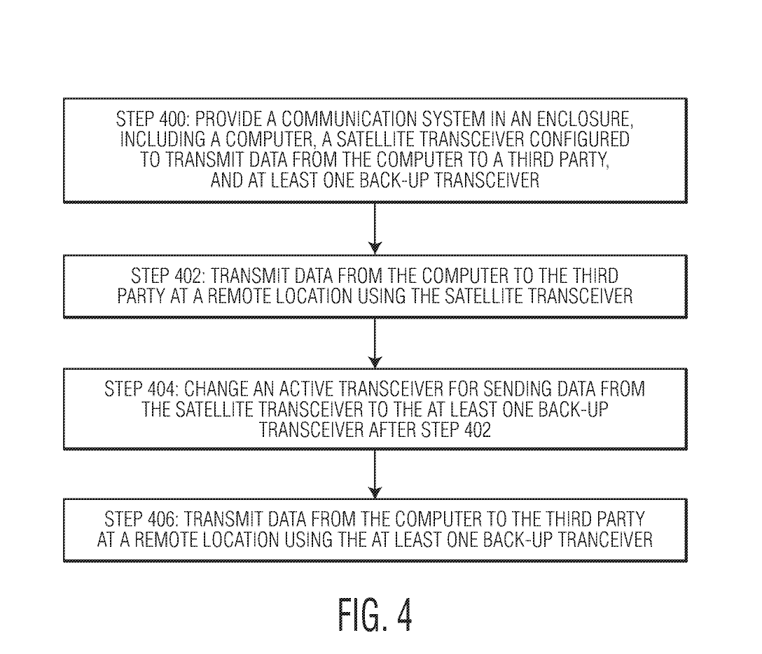

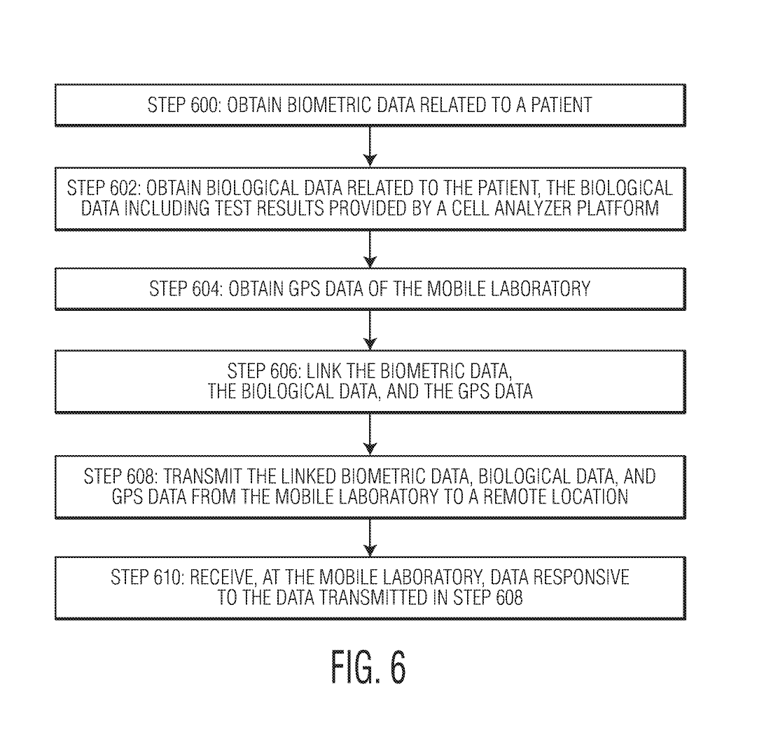

FIG. 4 is a flow diagram illustrating a method of operating a communication system. As is understood by those skilled in the art, certain steps included in the flow diagram of FIG. 4 (and FIG. 6) may be omitted; certain additional steps may be added; and the order of the steps may be altered from the order illustrated. At Step 400, a communication system is provided in an enclosure (e.g., an enclosure such as the housing shown in FIGS. 1A-1H, the enclosures shown in FIGS. 7A-7F, etc.). The communication system includes a computer, a satellite transceiver configured to transmit data from the computer to a third party, and at least one back-up transceiver. An exemplary communication system is system 300 illustrated in FIG. 3. At Step 402, data is transmitted from the computer to the third party at a remote location using the satellite transceiver (e.g., wherein the data transmitted may include some combination of biometric data related to patients, patient characteristics, biological data related to patients, and GPS data corresponding to the location of the communication system). Referring again to the exemplary communication system 300 shown in FIG. 3, a plurality of transceivers are provided.

Satellite transceiver 306a may be selected as the primary mechanism for data transmission to the third party (e.g., a global health organization). Thus, at a given location where satellite communication is available, data is transmitted according to Step 402. At Step 404, an active transceiver for sending data from the computer is changed. More specifically, the active transceiver is changed from the satellite transceiver to the at least one back-up transceiver. For example, while satellite communication using a satellite transceiver may be the preferred (and primary) mechanism for data transmission to the third party, satellite communication may not be available in all locations. Thus, at Step 404, the active transceiver is changed. Referring again to the FIG. 3, a plurality of potential back-up transceivers are provided. For example, it may be desirable to change the primary transceiver to cellular telephone transceiver 306c. This change may be automatic (e.g., because system 300 may be configured to sense that satellite communication is unavailable) or may be manual. After the switch is made at Step 404, data is transmitted at Step 406 from the computer to the third party at the remote location using the at least one back-up transceiver (e.g., the cellular telephone transceiver 306c). It will be appreciated that the communication system (e.g., and the mobile laboratory carrying the communication system) may be moved (e.g., by driving) between Step 402 and Step 406.

FIG. 5 is a block diagram illustrating linking of various data records. More specifically, for a specific patient, a biometric data record 502 (e.g., a data record related to biometric data obtained for a patient such as, for example, fingerprint scan data of the patient, a digital photograph of the patient, other patient biometrics described herein, etc., as well as patient characteristics described herein), a GPS data record 504 (e.g., a location of the mobile laboratory at the time the patient visited the laboratory, as provided by the satellite transceiver), and a biological data record 506 (e.g., a data record including information from the testing of the blood samples, such as, for example, outcomes of testing for certain pathogens or infectious agents) are provided. These various data records 502, 504, and 506 are stored within, or accessible by, computer 210. The records 502, 504, and 506 are linked into a single linked data record 508 for use as described herein.

FIG. 6 is a flow diagram illustrating a method of assembling patient data. At Step 600, biometric data related to a patient is obtained (e.g., for use as a unique identifier). Such biometric data may be obtained, for example, using a biometric input device such as a fingerprint scanning device. At Step 602, biological data related to the patient is obtained. The biological data includes test results provided by a cell analyzer platform (e.g., a flow cytometer, a fluorescent microscope, etc.). In order to generate the biological data, a biological sample (e.g., capillary blood) may be obtained from that patient. Referring, for example, to FIG. 2, after blood is drawn from a patient, the blood is processed using cell analyzer platform 208, with the resultant data being processed at flow metric diagnostic process 206. For example, this processed data (i.e., the biological data related to the patient) may include the outcome of a test to determine if the patient is infected by one or more pathogens. Further, the biological data may be processed through template-driven analytics in order to generate a clinical report, where the clinical report may be considered processed biological data. At Step 604, GPS data of the mobile laboratory is obtained (e.g., using information provided by satellite transceiver 306a in FIG. 3). At Step 606, the biometric data, the biological data, and the GPS data are linked together. For example, FIG. 5 illustrates the creation of linked data record 508. At Step 608, the linked biometric data, biological data, and GPS data are transmitted from the mobile laboratory to a remote location (e.g., for confirmation and/or use in surveillance programs). At Step 610, data responsive to the data transmitted in Step 608 is received at the mobile laboratory. For example, this responsive data may be a treatment for a condition, medical records of a patient, further instructions, etc.

Although aspects of the invention have been described in connection a mobile laboratory carried by a trailer or other vehicle (e.g., such as shown in FIG. 1A), the invention is not limited thereto. Mobile laboratories according to the invention may be contained in many different types of enclosures, housings, etc. For example, a small portable case (e.g., a ruggedized case) may be provide to contain the elements of the mobile laboratory. Such a portable case may have many different features useful in connection with a portable laboratory. One exemplary feature may be that the portable case may be buoyant in water (i.e., the case may float), particularly when the case is sealed.

FIG. 7A illustrates such an exemplary mobile laboratory 700. Mobile laboratory 700 includes a case 702 (e.g., a ruggedized, buoyant, case). Case 702 includes a plurality of carrying handles 704, and a top pulling handle 706 used in connection with pulling case 702 on wheels 714 similar to the manner in which a suitcase is pulled on wheels through an airport (see FIG. 7B, which illustrates an opposite end of mobile laboratory 700). Mobile laboratory includes cell analyzer platform 708 for testing blood samples (e.g., a flow cytometer, a fluorescent microscope, etc.), a computer 710 for receiving and analyzing data from cell analyzer platform 708 related to the tested blood samples, and a communication device 712 in communication with computer 710, for transmitting data related to the tested blood samples from computer 710 to a third party. These elements of mobile laboratory 700 (e.g., cell analyzer platform 708, computer 710, and communication device 712) are illustrated in block diagram form only in FIG. 7A, and it should be understood that such elements (as well as additional elements of mobile laboratories as described in this application) may be included in case 702 in any manner/orientation, as desired.

FIGS. 7C-7F illustrate details and/or variations of mobile laboratories included in portable cases such as in FIGS. 7A-7B. FIG. 7C illustrates a mobile laboratory 700a (similar to laboratory 700 shown in FIGS. 7A-7B). Mobile laboratory 700a includes a case 702a (e.g., a ruggedized, buoyant, case). Case 702a defines an inner space 720a for housing elements of mobile laboratory 700a (e.g., a cell analyzer platform, a computer, and a communication device). Inner space 720a is defined by inner walls of case 702a. A space is defined between outer walls of case 702a and inner walls of case 702a. In FIG. 7C, a plurality of spring members 722 are illustrated in this space between the inner walls and the outer walls. Such spring members 722 provide protection for the elements included in mobile laboratory 700, for example, in the event laboratory 700 is dropped, or experiences other potential damaging conditions. While spring members 722 are illustrated as being actual spring elements between the inner and outer walls, it is understood that spring members 722 may take any of a number of forms providing a desirable spring effect.

FIG. 7D illustrates a mobile laboratory 700b (similar to laboratory 700 shown in FIGS. 7A-7B). Mobile laboratory 700b includes a case 700b1 (e.g., a ruggedized, buoyant, case). Case 700b1 includes detachable end portions 700b2 and 700b3 that cover each end of case 700b1. End portions 700b2 and 700b3 are coupled to the center body portion of case 700b1 using pairs of fastening members 700b1a, 700b2a (e.g., clasp systems, locking fasteners, etc.). After end portions 700b2 and 700b3 are removed (e.g., during use of the mobile laboratory, such as in connection with a patient, at a given location), and interior portion of the center body portion of case 700b1 is accessible, as shown in FIG. 7E. As shown in FIG. 7E, shelves 700b1b are slidably engaged (e.g., using rails or the like) with the interior portion of the center body portion of case 700b1. Shelves 700b1b may be used to support elements of mobile laboratory (e.g., a cell analyzer platform, a computer, a communication device, etc.) which are not shown in FIG.

7E.

As will be appreciated by those skilled in the art, other types of portable cases may be utilized for a mobile laboratory. One such example is a mobile laboratory 700c shown in FIG. 7F. Mobile laboratory 700c includes a lid 700c2 hingedly coupled to a body portion 700c1. Lid 700c2 may be closed (and/or locked) with respect to body portion 700c1 using a pair of fastening members 700c1a, 700c2a (e.g., clasp systems, locking fasteners, etc.). As will be appreciated by those skilled in the art, elements of mobile laboratory 700c (e.g., a cell analyzer platform, a computer, a communication device, etc.) may be housed within body portion 700c1.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A mobile laboratory for screening patients using blood testing, the mobile laboratory comprising:
a cell analyzer platform for testing of blood samples;
a computer for receiving and analyzing data from the cell analyzer platform related to the tested blood samples; and
a communication device, in communication with the computer, for transmitting data related to the tested blood samples from the computer to a third party.

2. The mobile laboratory of claim 1 wherein the cell analyzer platform includes at least one of a flow cytometer and a fluorescent microscope.

3. The mobile laboratory of claim 1 further comprising a portable case equipped with wheels.

4. The mobile laboratory of claim 1 further comprising a housing and a trailer for carrying the housing.

5. The mobile laboratory of claim 1 further comprising a housing configured to be carried in a truck.

6. The mobile laboratory of claim 1 further comprising a housing and a plurality of solar panels configured to be mounted on the housing.

7. The mobile laboratory of claim 6 wherein at least a portion of the plurality of solar panels are configured to move between (a) a retracted position during transport of the mobile laboratory and (b) an extended position during operation of the mobile laboratory.

8. The mobile laboratory of claim 1 wherein the computer includes at least one data record linking (a) a biometric data record related to a patient, (b) a biological data record related to the patient, and (c) a GPS data record corresponding to a position of the mobile laboratory at the time the patient visited the mobile laboratory.

9. The mobile laboratory of claim 1 further comprising a biometric input device for providing biometric data from a patient to the computer.

10. The mobile laboratory of claim 9 wherein the biometric input device includes a fingerprint scanning device.

11. The mobile laboratory of claim 1 wherein the communication device includes a satellite transceiver.

12. The mobile laboratory of claim 11 wherein the communication device includes at least one back-up transceiver acting as a secondary transceiver if the satellite transceiver is not in operation.

13. A communication system comprising:
a computer for providing data to be transmitted;
a satellite transceiver configured to transmit data from the computer to a third party in a location remote from the communication system;
at least one back-up transceiver, as a back-up to the satellite transceiver, configured to transmit data from the computer; and
an enclosure holding the computer, the satellite transceiver, and the at least one back-up transceiver.

14. The communication system of claim 13 wherein the at least one back-up transceiver includes a cellular telephone transceiver.

15. The communication system of claim 13 wherein the at least one back-up transceiver includes a wifi transceiver.

16. The communication system of claim 13 further comprising a weather satellite receiver.

17. The communication system of claim 13 wherein the communication system is configured to automatically switch to use of the at least one back-up transceiver to transmit data from the computer after a determination is made that the satellite transceiver is unavailable.

18. The communication system of claim 13 wherein the communication system is included in a mobile laboratory and is configured to transmit medical data related to a patient to a third party.

19. The communication system of claim 13 further comprising an uninterruptible power supply within the enclosure.

20. The communication system of claim 13 wherein the enclosure has a volume of less than one cubic foot.

21. A method of operating a communication system, the method comprising the steps of:
(a) providing a communication system including a computer, a satellite transceiver configured to transmit data from the computer to a third party, at least one back-up transceiver, and an enclosure for holding the computer, the satellite transceiver, and the at least one back-up transceiver;
(b) transmitting data from the computer to the third party at a remote location using the satellite transceiver; and
(c) transmitting data from the computer to the third party at the remote location using the at least one back-up transceiver.

22. The method of claim 21 wherein the at least one back-up transceiver includes a cellular telephone transceiver.

23. The method of claim 21 further comprising the step of changing an active transceiver for sending data from the satellite transceiver to the at least one back-up transceiver after step (b) but before step (c).

24. The method of claim 23 wherein the step of changing is initiated because the satellite transceiver is not operational in a location of the communication system at step (c).

25. The method of claim 21 wherein the data transmitted in steps (b) and (c) includes data related to patients.

26. The method of claim 25 wherein the data transmitted includes biometric data related to the patients and biological data related to the patients.

27. The method of claim 26 wherein the data transmitted further includes GPS data corresponding to a position of the communication system at the time of transmission of the data.

28. The method of claim 26 wherein the biometric data transmitted includes fingerprint scan data.

29. The method of claim 26 wherein the biological data transmitted includes outcome data of tests performed using a cell analyzer platform.

30. The method of claim 21 wherein the communication system is moved from one geographic location to another geographic location between steps (b) and (c).

31. A method of assembling patient data for transmission from a mobile laboratory, the method comprising the steps of:
(a) obtaining biometric data related to a patient;
(b) obtaining biological data related to the patient, the biological data including test results provided by a cell analyzer platform;
(c) linking the biometric data and the biological data; and
(d) transmitting the linked biometric data and biological data from the mobile laboratory to a remote location.

32. The method of claim 31 further comprising the step of linking GPS data of the mobile laboratory with the biometric data and biological data prior to step (d).

33. The method of claim 31 wherein step (d) includes transmitting the linked biometric data and biological data to the remote location using a satellite transceiver.

34. The method of claim 31 wherein step (d) includes transmitting the linked biometric data and biological data to the remote location using at least one of (i) a satellite transceiver and (ii) a back-up transceiver, the satellite transceiver and the back-up transceiver each being included in an enclosure of a single communication system, and each being configured to transmit data from the computer.

35. The method of claim 31 further comprising the step of receiving, at the mobile laboratory, data responsive to the linked biometric data and biological data transmitted in step (d).

36. The method of claim 35 wherein the data responsive to the linked biometric data and biological data includes treatment instructions for the patient.

37. The method of claim 31 wherein step (a) includes using a biometric input device for providing at least a portion of the biometric data from the patient to the computer.

38. The method of claim 31 wherein the biometric input device includes a fingerprint scanning device.

39. The method of claim 31 further comprising the step of driving the mobile laboratory to a plurality of locations using a motorized vehicle, and repeating each of steps (a), (b), (c), and (d) at each of the plurality of locations.

40. The method of claim 31 wherein the remote location in step (d) corresponds to a global health organization.
